(19) United States
(12) Patent Application Publication
(10) Pub. No.: US 2014/0136258 A1
(43) Pub. Date: May 15, 2014

(54) PT2776

(71) Applicant: Hisham Gamal El-Din Mahmoud Fouad, 6th October City (EG)

(72) Inventor: Hisham Gamal El-Din Mahmoud Fouad, 6th October City (EG)

(21) Appl. No.: 14/074,854

(22) Filed: Nov. 8, 2013

(30) Foreign Application Priority Data
Nov. 30, 2010 (EP) EP10015133

(51) Int. Cl. G06Q 10/06

(52) U.S. Cl. CPC G06Q 10/06395; G06Q 10/063114
USPC 705/7.15

(57) ABSTRACT

The current invention is a feedback system for monitoring the efficiency of an organization (factory, industrial company or even service company) and down to the level of a worker in real-time manner, includes a supervisory and monitoring system. A database for storing data and an application program for analyzing it, giving reports in a real time manner, showing the efficiency, the total time of stoppage, and the reasons for these stoppages. The system can collect data through many types of physical sensors (temperature sensors, current sensors, electric pulse sensors and many others) which can be used for controlling different set of devices turning them on or off according to the needed scenario, also the system works through a LAN providing a communication system between all the workers attached to this system together with their direct supervisors and managers.

### CROSS-REFERENCES TO RELATED APPLICATIONS (IF ANY)

This is a Divisional Application of application Ser. No. 13/010,708 filed Jan. 20, 2011.

### STATEMENT AS TO RIGHTS TO INVENTIONS MADE UNDER FEDERALLY-SPONSORED RESEARCH AND DEVELOPMENT (IF ANY)

None

### BACKGROUND OF INVENTION

1. Field of the Invention

This invention relates generally to efficiency monitoring of an organization by helping to make sure that performance does not fall below a specified and desired percentage value as it monitors each node in the organization and links all the nodes of the organization together.

2. Background

Managing a company has always been an extremely difficult job which basically comprises three major tasks.

Firstly, the manager must get information regarding the actual operating conditions of the company. In the old days, the manager himself would gather this information by walking around the company premises or by calling lower level managers of the company. Nowadays, faster and better communication means exist for sending the information to the manager even in real time.

Secondly, the manager has to organize all the information in such a way that it allows for performing an orderly analysis of the situation and for deciding which measures to take in order to keep the company processes under control. This task is also a difficult one, since it involves extracting conclusions in view of a number of pieces of information coming from a plurality of sources and frequently having different forms and formats. Additionally, some of the available pieces of information may be either missing or not recently updated.

Finally, the manager has to perform certain actions on the devices or tasks causing global performance drops in the company in order to maintain such global performance above a certain efficiency and quality threshold. As before, the manager may have to do this himself, or either call or otherwise communicate with lower level managers for giving them the pertinent orders.

Even though nowadays a great number of tools exist which could aid in performing this job in a more structured and reliable manner, it is still carried out very much as explained above, since no system has been yet developed for automating the above explained steps.

There is still room for improvement in the art.

### SUMMARY OF THE INVENTION

### Object of the Invention

An object of the invention is a system for monitoring in a real-time manner the efficiency and/or internal quality level of a company down to the level of individual tasks (if performed by a worker) or individual devices, as well as for stopping said devices or tasks.

Another object of the invention is a procedure for operating the above system in order to calculate the efficiency and/or quality of each of the tasks, either individually or in a grouped fashion, and to stop certain tasks having a low efficiency or quality in order to maintain the overall efficiency and quality level of the whole company, or of a certain group of workers tasks, above a certain threshold.

### Summary

The current invention is a feedback system for monitoring the efficiency of an organization (factory, industrial company or even service company) and down to the level of a worker in real-time manner, it includes a supervisory and monitoring system, a database for storing data and an application program for analyzing it, it gives reports in a real time manner, showing the efficiency, the total time of stoppage, and the reasons for these stoppages.

The system can also be used for collecting data through many types of physical sensors (temperature sensors, current sensors, electric pulse sensors and others) this data can be used for controlling different set of devices turning them on or off according to the needed scenario, also the system works through a LAN providing a communication system between all the workers attached to this system together with their direct supervisors and managers.

In short this system is equivalent to as if the management of the organization has dedicated a supervisor or an industrial engineer for each worker that is holding a stopwatch in his hand and calculating the time for each finished process made by the worker or the employee, comparing it to the standard operation time for this operation and giving this worker a real time feedback about his current efficiency and performance with the option to even shut down the machine or the equipment he is using in this process if the deviation from the standard operation time is not accepted, at the same time the management has installed a PC for each worker giving the option to communicate with all of them after connecting them to a standard Ethernet network, all of these are made in an affordable economical scenario.

Definitions:

ASC: Automatic Supervisor and Control system.

Node: A worker (or employee), a group, or a department.

GPIO: General purpose input/output is an interface available on some devices.

Andon: Is a manufacturing term referring to a system to notify management, maintenance, and other workers of a quality or process problem.

### BRIEF DESCRIPTION OF THE DRAWINGS

Without restricting the full scope of this invention, the preferred form of this invention is illustrated in the following drawings:

FIG. 1a shows the ASC in block diagram form;

FIG. 1b a diagram of the different elements forming part of the system of the invention;

FIG. 2 shows an organization structure; and

FIG. 3 shows a schematic diagram of the company organization.

### BRIEF DESCRIPTION OF THE PREFERRED EMBODIMENTS

There are a number of significant design features and improvements incorporated within the invention.

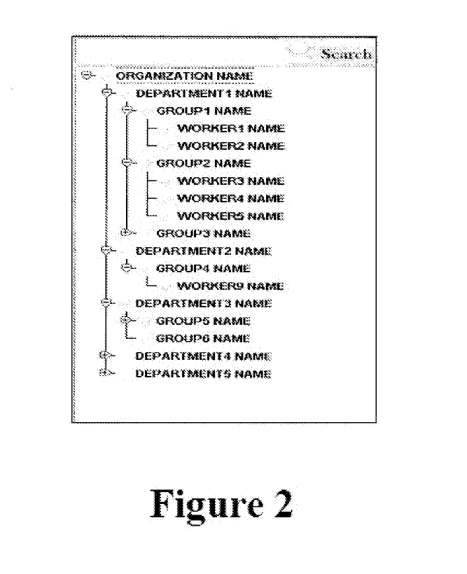

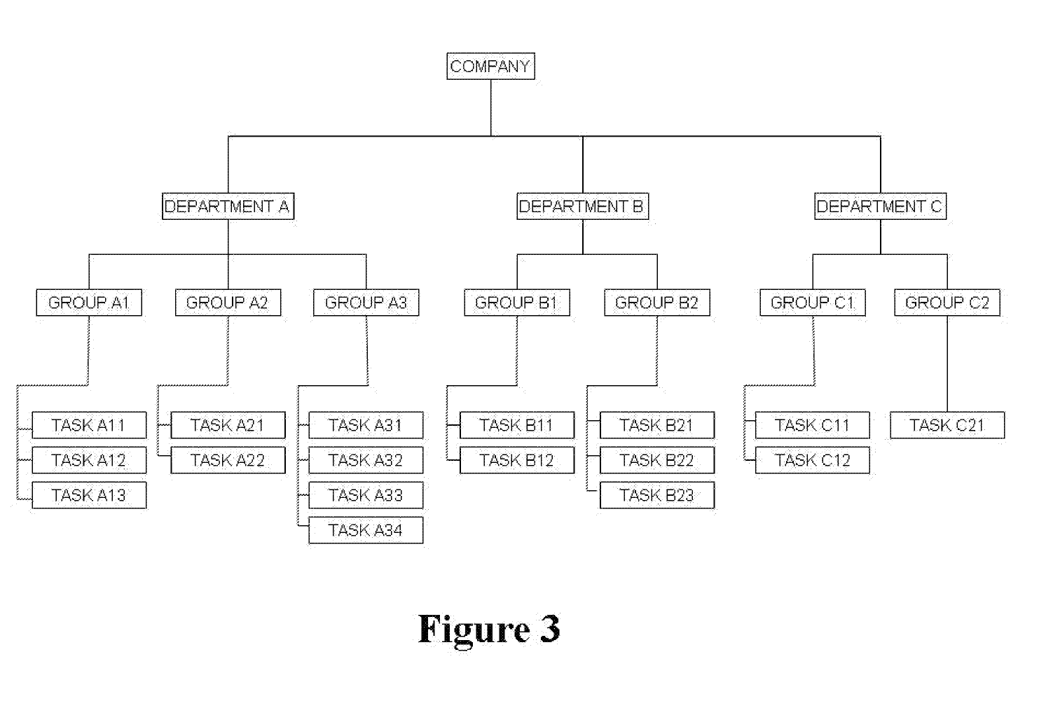

The current invention is a software system which allows monitoring the whole organization, it consists of a tree; as shown in FIG. 2 and FIG. 3, which has many nodes, where each node represents a department in the organization, each department has a tree of groups below its node, each group acts also as a node which consists of many workers, not all users of this system have the access to monitor all the nodes, this system has privileges so each department manager has the ability to monitor his department nodes only, also group leaders have access to the nodes of their groups, or any other privileges as set by the system administrator. The organization is represent in FIG. 3 by a tree diagram, could correspond, for example, to an automotive part manufacturing company. Each task would then correspond to the job of a worker in a production line. A Group of tasks would form a complete production line. The various production lines required for manufacturing a certain finished part A, B or C, such as a steering column, would form a Department. The aggregation of the Departments, each of which would then correspond to a different finished part, would then form the Company.

The User can watch the current efficiency in real time manner of any node or of the whole organization, also with this system a User can get the accumulative efficiency for a desired period of time entered by the user of the system, they can get details about any node in real-time, the system generates reports with total stoppage time for any node, they can also send messages to any node of the system, with supervisory and monitoring system the whole organization is monitored and under control.

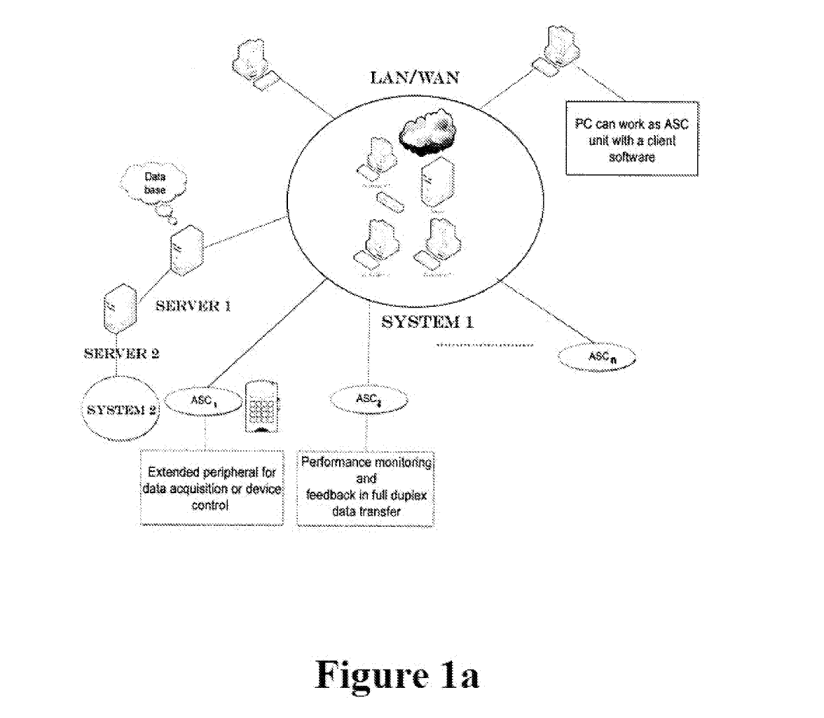

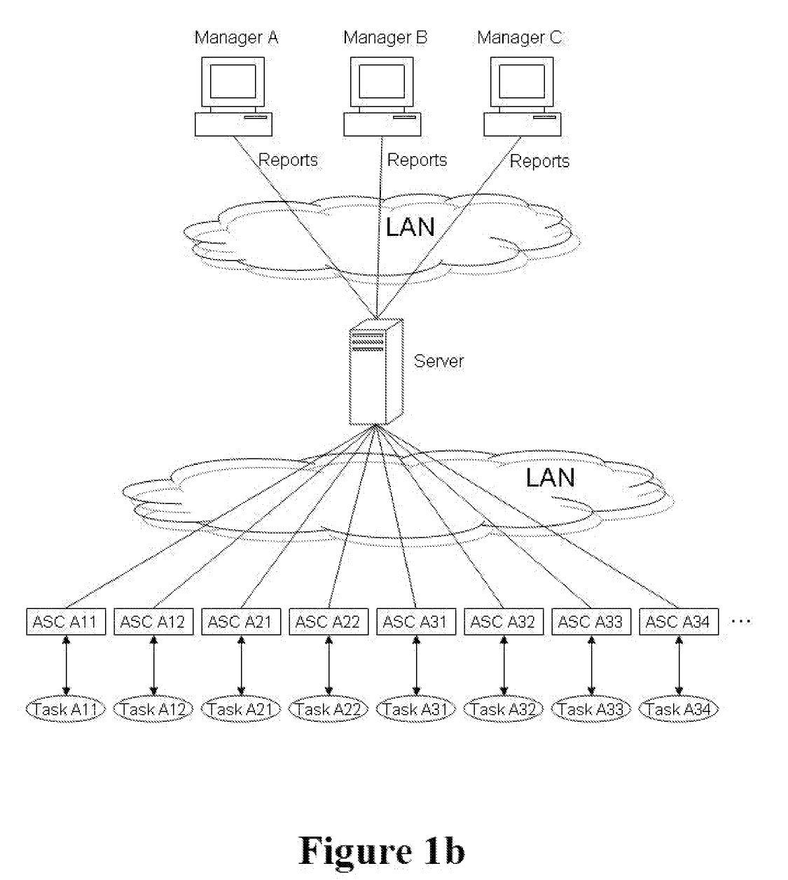

FIG. 1a shows the Automatic Supervisor and Control system (ASC) in block diagram form, called the system 1. It consists of a server which is called server1 and includes the database used for storing data and the programs which analyze these data and generate the detailed reports, the system includes also ASC units called ASC1, ASC2 to ASCn, and these are the units which used for logging in the system, collecting data and controlling other devices according to the efficiency of the node(s) operating theses device(s) as ASC unit can turn a machine off when the efficiency is below a required value and generate an alarm, the figure shows also a PC that can work as an ASC unit with a client software, all ASC units are connected to the network as simple as connecting a PC to a network.

FIG. 1b shows also another ASC where the ASC can be expanded and that is done by connecting server2 with server1 up to server n, each server can connect to a maximum number of ASC units dependent on the processing power of this server, and servers can be cascaded to increase the total number of ASCs as needed.

The system 1 monitors the performance of an organization in real-time collects data from the level of workers in a specific group in a specific department; the collection of data is done using ASC units by automatic or manual operations:

1—Automatic operation: by using sensors which can be connected to ASC units via General purpose input/output (GPIO),

2—Manual operation: by the worker himself using barcode readers or directly using the ASC unit's user interface through keypad or touch screen (by pressing the count button each time he finishes the operation he is doing).

There is a software ASC client, as persons in the organization who have already PCs connected to the LAN do not need a physical hardware ASC unit, so they connect to the system with software ASC client installed on their PCs.

The data is transferred to the database through the LAN (local area network) as the ASC unit is connected to the network as simple as connecting a PC to a LAN, the ASC unit can also be wirelessly connected to the LAN.

The collected data is stored in the database and is analyzed to get the current efficiency and the accumulative efficiency for any node or for the organization. Detailed reports are generated in real-time.

In more detail, the present invention discloses an automatic supervision and control system for a company which comprises a plurality of tasks performed by a worker or a group of workers (or employees), the system comprising first and second pluralities of ASC units, a central server and at least one managing station. In the following paragraphs each of these elements is further described.

a) A First Plurality of ASC Units

The ASC units are devices gathering the information relating to the tasks of the company, and may preferably also stop the task in case its efficiency or quality level is below certain threshold. In this invention, there is a first plurality ASC units associated to each worker task of the company in order to acquire information relating to the efficiency of that specific task. However, it should be understood that it would be possible to assign no ASC unit for certain tasks, or that a single ASC unit may monitor a plurality of sub-tasks. The ASC unit may be dedicated device, a PDA or a smartphone. Further, the ASC unit may consist of a conventional PC having a software ASC client, as people in the organization who have already PCs connected to the LAN do not need a physical hardware ASC unit in order to have their tasks monitored.

Each ASC unit comprises data acquisition means configured for detecting when a task has been finished and the stoppage times. According to a preferred embodiment of the invention, these data acquisition means are manual, in which case an employee in charge of the pertinent task would have to manually input the time when the task is finished and the stoppage times, for example by means of a barcode reader, a keypad, a touch screen, a push button, etc. Thus, in a preferred embodiment the ASC units comprise a barcode reader. According to another preferred embodiment, the data acquisition means are automatic sensing means, such as a GPIO (General Purpose Input Output) connected to the ASC unit. These could be, for example, a temperature sensor, a current sensor, an electric pulse sensor, a proximity sensor, a vibration sensor, and generally speaking any kind of sensor that can be connected to the ASC unit according to each scenario.

In a further preferred embodiment of the invention, the ASC unit also comprises actuating means configured for stopping said task in case its efficiency or quality level is below a certain threshold. For example, these means could actuate a power switch or the like for shutting down a machine.

In a still further preferred embodiment of the invention, the system further comprises means for sending SMS between the managing stations and the ASC units (a two way communication channel). That way, all managers and leaders of the organization are at all times in touch with all the workers they are responsible for.

b) A Second Plurality of ASC Units

Additionally, some ASC units similar to those described above are given to a number of quality inspectors. The quality inspectors walk around the company premises supervising the tasks and sending this quality information to the server by means of a of ASC units.

Therefore, these ASC units also have a “Quality Mode” which allows these inspectors to enter data such as the error count or PPM of a certain task. In this case, the data acquisition means may comprise merely a keypad.

c) A Central Server

The central server is connected to the first and second pluralities of ASC units for receiving the information acquired by said ASC units. The central server comprises:

A processing unit configured for calculating the efficiency and/or quality of each task, either individually or in a grouped fashion. As mentioned above, the efficiency of a task is calculated taking into account the time it took for the task to be finished in comparison with a corresponding standard operation time for that specific task, while the quality of a task is calculated by summing all errors reported by the inspectors corresponding to a specific task. Once the efficiencies and/or qualities of the tasks in a certain group or department of the company have been calculated, the processing unit can calculate the overall efficiency and/or quality of that group or department. The processing unit can also make reports showing the efficiency, quality level (PPM or just error count), the total time of stoppage, the reasons for these stoppages, etc. All these calculations are made in real time according to a method that will be set out later on in the present application.

A database for storing the data on the tasks sent by the ASC units, as well as the individual or accumulated efficiencies and qualities calculated by the processing unit.

d) At Least One Managing Station

Each person in charge of a group, a department, the manager of the whole company, etc. has a managing station connected to the central server. The managing station is usually simply a PC connected to the server by means of a LAN network. The managing station is configured for receiving reports relating to the efficiencies and quality levels (PPM or error count) calculated by the processing unit and showing them in real time to the pertinent person. As will be explained later on in the present document, the system will only allow each person access to the efficiency or quality data relating to the tasks he is responsible for. For example, the general manager of the company may look up the overall efficiency and the overall quality level of the whole company, as well as the efficiencies and quality levels of all departments, groups and individual tasks. However, each department manager will only have access to the efficiency and quality level data corresponding to that department and to the tasks of that specific department.

The connection between the server and the ASC units and managing station is carried out by means of a LAN. For example, an Ethernet or Wifi network may be employed for this purpose. Alternatively, in case the company premises so require, an Internet connection can be used for connecting these elements. In this manner, all workers having an ASC unit and their direct supervisor and managers having managing stations are in continuous communication.

There are three kinds of reports that can be generated, to fully get a detailed representation about the organization:

1—An Object-based report:

This object could be a worker, a group, a department or the whole organization, this object-based report has two branches:

a—The first one is based on the current efficiency of the object in real-time and determines the performance of the organization depends on its departments and workers.

b—The other one is based on the accumulative efficiency of the object which determines the performance depends on a period of time.

2—An Operation-based report:

This operation can be a task, a production process or any type of processes, this operation can be performed by one worker or more than a worker. This report is also divided into two branches:

a—The first one is based on the current performance of an operation.

b—The second is based on the accumulative efficiency due to a specified period of time.

3—A Stoppage-based report:

This report is divided into two independent reports:

a—The first one refers to the total time which an operation or an object has been stopped regardless of the reason of this stoppage.

b—The second type of stoppage-based report refers to the total time of stoppages due to a specific department or cause so the reason of stoppage is taken into consideration.

The equation which is used for calculating the Current Efficiency is as shown:

$${η}_{current} = \frac{Standard Time Duration}{Actual Time Duration} * 100$$

Where the Standard Time Duration is stored for each process and the Actual Time Duration is calculated as shown:

$$Actual\_Time \_Duration = τ ( n ) - τ ( n - 1 ) - {\sum }_{t = τ ( n - 1 )}^{τ ( n )} Stoppage\_Durations$$

Where τn represents the time of the last finished process, τ(n−1) represents the time of the previous finished process and Stoppage Durations are the periods of time in which the process was stopped.

The calculation of the accumulative efficiency depends on the history of data which is stored in the database in real-time manner, when a task or a process is achieved with a specific efficiency the current efficiency is calculated and also a copy of it is stored to contribute in the calculation of the accumulative efficiency upon a desired period of time.

This period could be a month, a week, a day or even the last hour. The equation which is used for calculating the Accumulative Efficiency is as shown:

$${η}_{Acc ( n )} = \frac{{η}_{Current ( n )}}{n} + ( {η}_{Acc ( n - 1 )} * \frac{n - 1}{n} )$$

$$where n \neq 0$$

Where n represents the index of the finished processes or tasks so at n=0 the process has not been started yet and, at n=1 the process has just begun and was achieved for the first time, at this time the Accumulative Efficiency equals to the Current Efficiency, each time the process is achieved the Accumulative Efficiency is updated with the new value, the ASC system has the option which allows choosing the minimum time duration unit of calculating the Accumulative Efficiency, so it can give the Accumulative Efficiency for the last hour and also for a fraction of an hour, as the minimum time duration unit can be adjusted for fast processes which have a low time of achieving so it can give the Accumulative Efficiency for the last few minutes, a history of Accumulative Efficiencies is stored in the data base due to the required minimum time duration unit and these stored data are used to get the Accumulative Efficiency over any required period of time as shown:

$${η}_{Acc over any period of time} = \frac{{η}_{Acc ( to )} + {η}_{Acc ( to + dt )} + {η}_{Acc ( to + 2 * dt )} + … + {η}_{Acc ( to + n * dt )}}{n + 1}$$

$$where ( {t}_{0} + n * dt ) < {t}_{f}$$

Where (η_{Acc}) is the Accumulative Efficiency stored in the database for the instant of time t, t₀ is the start time of the period, dt is the minimum time duration unit defined by the user, n is the number of samples stored in the database and t_{y} is the end time of the period, this equation can be written as shown:

$${η}_{Acc over any period of time} = \frac{{\sum }_{t = t 0}^{t = tf} {η}_{Acc ( t )}}{number of samples}$$

A supervisory and monitoring system is an office-based computer system, this system enables monitoring all nodes in the organization, it has privileges as not all users of this system have the ability to watch and monitor all the nodes of the organization, administrators only have access to all nodes of the organization, team leaders have access to monitor their workers in the same team, also department managers have access to all objects in their departments, or can be configured by any desired scenario by the system administrator according to the needs of the organization.

The supervisory and monitoring system can determine the node in the organization which cause the efficiency of the organization goes under a predefined critical value, alert messages are sent to the nodes which cause the performance goes down, department managers, group leaders and supervisors make decisions depend on the current state, supervisory and monitoring system helps keep the efficiency of the organization stable and above a critical predefined value and helps taking decisions quickly as the organization is monitored and its parts are connected together through the ASC units and the performance is watched in real-time.

Examples for using ASC Units in Control Systems

The ASC can be used to control machines and devices or for monitoring.

The first example is controlling air-conditioners in an organization. This organization can be a factory, a supermarket or any other organization, and this is done using the GPIO in the ASC unit, the control process is due to a pre-defined data stored in the database. Reports which are generated show details of the dates of turning the air-conditioners on or off. They show also the history of stoppages. A supervisory and monitoring system is controlling the air-conditioners in real-time and updates the database at any time with the new modifications.

The second example is monitoring the temperatures of fridges in a supermarket. It is also done using the GPIO in the ASC unit. Reports are generated show the temperatures of the fridges in real-time. Diagrams are also generated with the temperatures due to defined periods of time. Alert messages are sent when the temperature of a fridge exceeds a pre-defined stored value in the database.

The third example is using the ASC units as an Andon display to notify management, maintenance, and other workers of a quality, machine stoppage or process problem, because the ASC unit includes an LCD and an alarm, so messages can be sent through the network then displayed on the LCD or notify by turning the alarm on.

The fourth example is controlling a press, and that is achieved by using the GPIO, which allows connecting sensors, switches and any other peripherals to the ASC unit. Usually a worker works on a manually operated press gives a signal to the press to start a press through a switch operated by the worker, in this scenario the ASC gets its trigger automatically from the switch sensing sensor and calculates the efficiency after comparing the Standard Operation Time recorded in the database and the actual operation time derived from subtracting the time of next signal minus the time of the previous signal, so in such scenario the ASC can be used to totally automatically stop the machine if the efficiency is below a certain threshold, lighting up the red LED in the ASC unit and also generating a peep sound from the peeper installed inside the ASC unit.

The fifth example is monitoring the scrap quantity in factories like Wiring Harness industry or similar industries, there is a Production Card generated from the system containing a card number and this card number links in the system to a number of terminals in this card number. So the worker will enter first the card number then the terminal number then start working, the presses of the worker are saved automatically and can be used for calculating the number of terminals used in the current job from which the scarp or waste quantity can also be calculated automatically and even the system can automatically stop the press or the machine if the scrap or waste quantity exceeds a certain threshold. The following is the equations used for previous calculations:

$$Scrap per job = Total presses - Actual achieved terminals$$

$$Scrap per node = {\sum }_{n = 1}^{n = Total child nodes} Scrap per job ( n )$$

$$Total Scrap = {\sum }_{n = 1}^{n = Total nodes} Scrap per node ( n )$$

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. Automatic supervision and control system for a company comprising a plurality of tasks, characterized by comprising:
a) a first plurality of ASC units, each ASC unit being associated to a corresponding task of the company, wherein each ASC unit comprises data acquisition means configured for detecting when a task has been finished;
b) a second plurality of ASC units configured for allowing quality inspectors to enter quality data on the tasks;
c) a central server connected to the first and second pluralities of ASC units, the central server comprising:
a processing unit configured for calculating the efficiency and/or quality level of each task, either individually or in a grouped fashion; and
a database configured for storing the data on the tasks sent by the ASC units, as well as the efficiencies and quality levels calculated by the processing unit; and
d) at least one managing station connected to the central server, the managing station being configured for receiving the efficiency and quality levels calculated by the processing unit.

2. A system according to claim 1, wherein the data acquisition means comprise manual means.

3. A system according to claim 1, wherein the data acquisition means comprise automatic sensing means.

4. A system according to claim 3, where the automatic sensing means comprises at least one of the following: a temperature sensor, a current sensor, an electric pulse sensor, a proximity sensor or a vibration sensor.

5. A system according to claim 1, where each ASC unit further comprises actuating means configured for stopping said task in case its

6. A system according to claim 1 any of the previous claims, where each ASC unit further comprises an LCD for displaying messages sent from the managing stations or from the server.

7. A system according to claim 1, where each ASC unit is one of the following: a PDA, a smartphone, a dedicated device or a software ASC client run in a conventional computer.

8. A system according to claim 1, where the connection between the server and the ASC units and managing station is carried out by means of a LAN.

9. A system according to claim 2, where each ASC unit further comprising an LCD for displaying messages sent from the managing stations or from the server.

10. A system according to claim 3, where each ASC unit further comprises an LCD for displaying messages sent from the managing stations or from the server.

11. A system according to claim 4, where each ASC unit further comprises an LCD for displaying messages sent from the managing stations or from the server.

12. A system according to claim 5, where each ASC unit further comprises an LCD for displaying messages sent from the managing stations or from the server.
